(19) United States
(12) Patent Application Publication
(10) Pub. No.: US 2006/0104861 A1
(43) Pub. Date: May 18, 2006

(54) Test sensor transport mechanisms and methods

(76) Inventors: Bryan Keith Windus-Smith, Elmswell (GB); Neil Kenneth Gair, Inverness (GB)

Correspondence Address: Kagan Binder PLLC, Maple Island Building, 221 Main Street North, Ste. 200, Stillwater, MN, 55082, US

(21) Appl. No.: 11/240,348

(22) Filed: Sep. 30, 2005

Related U.S. Application Data
(60) Provisional application No. 60/615,555, filed on Sep. 30, 2004.

(51) Int. Cl. G01N 35/00

(52) U.S. Cl. 422/63; 422/64

(57) ABSTRACT

Testing devices for measuring the concentration of an analyte in a fluid sample are provided. More particularly, transport mechanisms for use with such testing devices for moving a test sensor or the like between various operating positions of a testing device such as a storage position and a test position are described.

This application claims the benefit of U.S. Provisional Application Ser. No. 60/615,555, filed Sep. 30, 2004, entitled, “TEST SENSOR DISPENSING MECHANISM AND METHOD OF USE,” the entire disclosure of which is incorporated by reference herein for all purposes.

### TECHNICAL FIELD

The present invention relates generally to testing devices for measuring the concentration of an analyte in a fluid sample. More particularly, the present invention relates to transport mechanisms for use with such testing devices for moving a test sensor or the like between various operating positions of a testing device such as a storage position and a test position. The present invention also relates to methods of making and using such transport mechanisms and testing devices.

### BACKGROUND

Metering systems for measuring an analyte or indicator (e.g., glucose, HbAlc, lactate, cholesterol) in a fluid such as a body fluid (e.g., blood, interstitial fluid (ISF), urine) typically make use of disposable test sensors. A test sensor that is specific for the analyte or indicator of interest may be inserted into a metering system, within which it becomes physically and electrically connected with a measuring circuit of the metering system. Thus, following application of a sample to a test sensor, a measurement result may be obtained providing an indication of the quantity of the analyte or indicator within the sample.

The insertion of a test sensor into a metering system is often a manual operation in which a user of the metering system must transfer a test sensor from a vial or storage container into a connector port of a metering system. The vial in which test sensors are stored provides a controlled atmosphere that is required to preserve the viability of the test sensor. A user of the metering system is therefore required to open the vial, remove a test sensor, and reseal the vial every time a measurement is made. This process can be both time-consuming and cumbersome, depending on the type of vials and metering systems used and may result in poor testing procedures and/or inaccurate test results.

An improvement to these metering systems described above involves using a removable and replaceable cassette or cartridge of test sensors within the metering system. With this improvement, the user is not required to manually transfer a test sensor from a vial to a connector prior to making a measurement. A strip may instead be transferred directly from the cartridge into a test position using some type of manually activated system. This type of system can position a portion of the strip outside the meter casing so that a user can deposit a sample on it.

Metering systems using cartridges or other multi-strip storage components are typically somewhat larger than systems that are designed for manual insertion of a single strip at a time. This increased size of the metering systems with cartridges is due to both the size of the cartridge and the size of the mechanisms used within the device for moving a strip from the cartridge to the test position, such as motors, conveyors and the like. In order to minimize the size of these metering systems, it is common for the strips to be provided in a certain orientation (e.g., vertically positioned as compared to a display surface of the device) and moved in the same general orientation to the test position. While this movement and orientation of each strip can be acceptable in many circumstances, it may be more convenient in some circumstances to provide a metering system that is capable of reorienting the strips between their position in the cartridge and their test position.

### SUMMARY

The present invention provides transport mechanisms for metering systems that can dispense a test sensor or strip from an internal cassette or cartridge of the metering system in an orientation such that a user can view both the sample application window of the strip and the visual display of the metering system simultaneously. This is especially advantageous if, for example, the metering system is to be used on a tabletop or other flat surface where a user would move a lanced fingertip up to the test sensor to apply a sample of blood.

In one aspect of the present invention a transport apparatus is provided for moving a test sensor between a first location in an analyte measurement system where the test sensor has a first planar orientation to a second location in the analyte measurement system where the test sensor has a second planar orientation that is different from the first planar orientation. The transport apparatus comprises a frame, driving device, connector, and first and second reorientation systems. The driving device can be operatively integrated with the frame. The connector is capable of carrying a test sensor and may include a gripper, jaw, holding mechanism, or connector, or the like. The connector is driveable along a conveying direction by the driving device and positionable at a first location where a test sensor engaging surface of the connector has a first planar orientation. The first reorientation system cooperates with the driving device to rotate the connector in a first rotational direction having an axis of rotation normal to the conveying direction. The first reorientation system may comprise a pinion gear driven by a rack gear, for example. The second reorientation system cooperates with the driving device to rotate the connector in a second rotational direction. The second rotational direction has an axis of rotation extending along the conveying direction so that the connector is positionable at a second location where the test sensor engaging surface of the connector has a second planar orientation different from the first planar orientation. The second reorientation system may comprise one or more guiding surface incorporated with the connector and frame, for example.

In another aspect of the present invention, an analyte measurement system is provided. Generally, the analyte measurement system comprises a housing, indexing device, and transport device. The indexing device is provided within at least a portion of the housing. The indexing device can receive a cassette having a plurality of test sensors and position a test sensor of the plurality of test sensors at a storage location where the test sensor has a first planar orientation. The transport device is provided within at least a portion of the housing and can move a test sensor between the storage location and a test location where the test sensor has a second planar orientation different from the first planar orientation.

In yet another aspect of the present invention, a method of providing a test sensor in a test position relative to an analyte measurement system is provided. The method comprises the steps of: providing an analyte measurement system with a cassette having one or more test sensors; positioning a test sensor of the one or more test sensors of the cassette in a storage location where the test sensor has a first planar orientation; removing the test sensor from the cassette with a transport device of the analyte measurement system; rotating the test sensor with the transport device on a first rotational axis by a first angular rotation relative to the position of the test sensor in the storage location; rotating the test sensor with the transport device on a second rotational axis normal to the first rotational axis by a second angular rotation relative to the position of the test sensor in the storage location; and positioning the test sensor at a test position where the test sensor has a second planar orientation different from the first planar orientation.

### BRIEF DESCRIPTION OF THE DRAWINGS

These and other features, aspects, and advantages of the present invention will become better understood with regard to the following description, appended claims, and accompanying drawings where:

FIG. 1 is a top view of an exemplary metering system in accordance with the present invention showing in particular a test sensor partially extended out of a housing the metering system in a test position and having an orientation where the test sensor is viewable together with a display screen of the metering system in accordance with the present invention;

FIG. 2 is a top view of the metering system of FIG. 1 with an upper housing portion of the metering system removed and showing in particular a cartridge assembly and transport mechanism that can be used to move a test sensor from a storage position in the cartridge assembly where the test sensor has a first planar orientation to the test position of the metering system where the test sensor has a second planar orientation different from the first planar orientation in accordance with the present invention;

FIG. 3 is a perspective view of a test sensor that can be used with the metering system of FIGS. 1 and 2 in accordance with the present invention;

FIG. 4 is a perspective view of the cartridge assembly and transport mechanism of the metering system FIGS. 1 and 2 shown separate from the housing of the metering system;

FIG. 5 is a perspective view of the transport mechanism of FIG. 4 shown separate from the cartridge assembly;

FIG. 6 is a perspective view of a lead screw of the transport mechanism shown in FIG. 5 and that is used to drive a carriage and associated connector of the transport mechanism along a conveying direction in accordance with the present invention;

FIG. 7 is a perspective view of a frame of the transport mechanism shown in FIG. 5 showing a guide slot having guiding surfaces for guiding the carriage as driven by the lead screw of the transport mechanism;

FIG. 8 is an exploded perspective view of the connector and carriage of the transport mechanism shown in FIG. 5;

FIG. 9 is a perspective view of a cartridge assembly and transport mechanism in accordance with the present invention showing an connector of the transport mechanism in the position in which the connector can engage with and remove a test sensor from a storage position of the cartridge assembly with the test sensor in a first planar orientation;

FIG. 10 is a perspective view of the cartridge assembly and transport mechanism of FIG. 9 where the connector has removed the test strip from the cartridge assembly;

FIG. 11 is a perspective view of the cartridge assembly and transport mechanism of FIG. 10 where the connector has been linearly advanced and has also rotated the test strip about 180 degrees from the position shown in FIG. 10;

FIG. 12 is a perspective view of the cartridge assembly and transport mechanism of FIG. 1 where the connector has rotated the test strip about 90 degrees from the position shown in FIG. 1; and

FIG. 13 is a perspective view of the cartridge assembly and transport mechanism of FIG. 11 where the connector has linearly advanced the test strip from the position shown in FIG. 12 to a test position.

### DETAILED DESCRIPTION

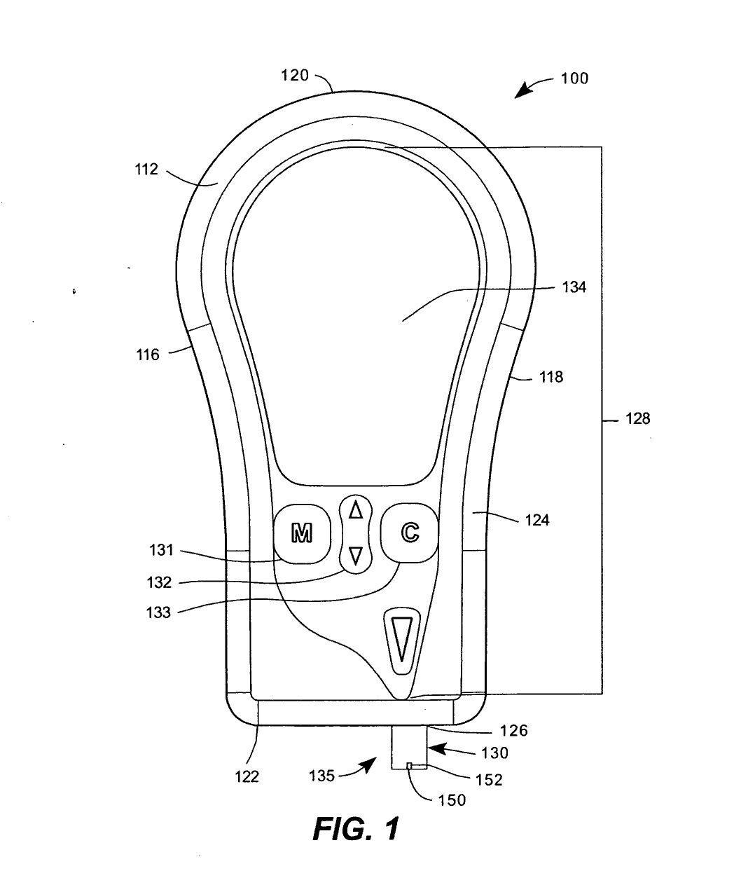

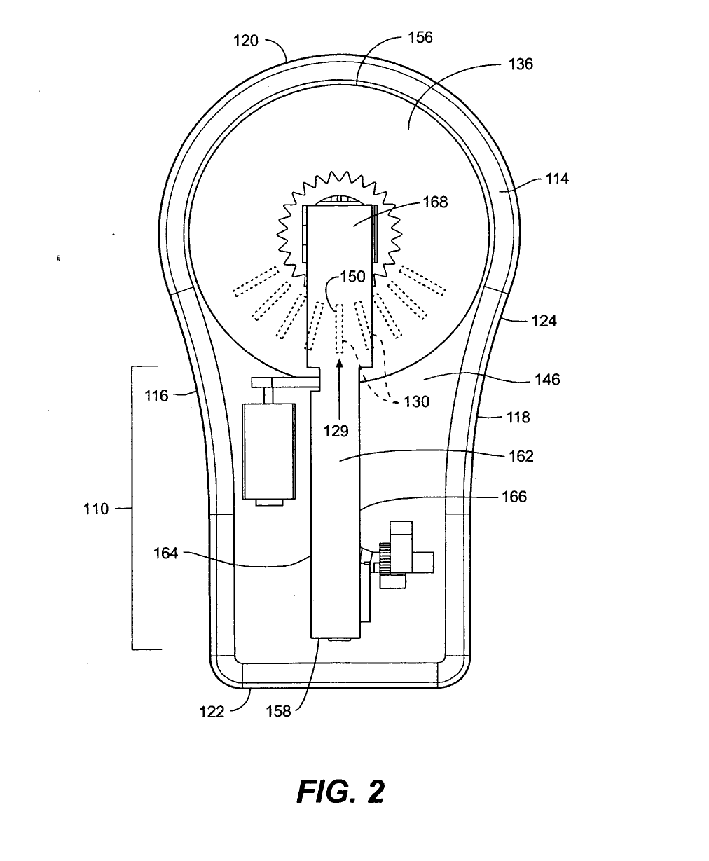

Referring to FIGS. 1 and 2, exemplary metering system 100 in accordance with the present invention is illustrated. Metering system 100 is configured to measure an analyte in a sample of body fluid such a blood, for example and may include an electrochemical and/or photometric measuring device and associated circuitry (not shown). Analytes that may be measured using metering system 100 include, but are not limited to, glucose, HbAlc, lactate, and cholesterol, for example. In accordance with the present invention, metering system 100 includes transport mechanism 110 and cartridge assembly 136 holding multiple test sensors 130. Transport mechanism 110 functions to move a single test sensor 130 from storage position 129 of cartridge assembly 136, where the test sensor 130 has one spatial orientation, to test position 135, where test sensor 130 has a different spatial orientation and is in operative communication with the testing device. After a test is performed, transport mechanism 110 can, if desired, return a used test sensor to cartridge assembly 136 for storage until the test sensor is discarded.

As illustrated, cartridge assembly 136 provides a plurality of test sensors 130 radially arranged on end. In use, cartridge assembly 136 can be rotationally indexed to position any desired test sensor 130 at storage position 129 where it can be accessed by transport mechanism 110. As shown, test sensor 130 has sample application area 150 at distal end 140 of test sensor 130. Thus, as illustrated, sample application area 150 is the last portion of a test sensor 130 to leave cartridge assembly 136 when it is removed for transport to test position 135. In the illustrated embodiment, transport mechanism 110 therefore functions to turn test sensor 130 around (approximately a 180 degree rotation about a first axis) and rotate test sensor 130 approximately 90 degrees about a second axis so that sample application area 150 can extend out of metering system 100 as shown in FIG. 1. Depending on the particular cartridge assembly configuration and metering system design, various rotational and/or linear movements can be used independently or in combination to move a test sensor between desired locations in accordance with the present invention.

Any known or future developed test sensors or test strips, including those with integral lancing capability, cartridges, cassettes, feed devices, or the like can be used in accordance with the present invention. The present invention is particularly applicable where it is desirable to reorient a test sensor when moving between various locations such as a storage location and a test location where it is used. In this regard, transport mechanism 130 is preferably designed to provide the desired conveying and rotation as described with respect to the exemplary transport mechanism 110 below. Exemplary cartridge assemblies that can be used are described in Applicant's copending U.S. patent application having LifeScan Attorney Docket No. DDI 5058 USNP1, entitled “Cassette Assemblies for Testing Devices and Methods, and filed on even date herewith, the entire disclosure of which is fully incorporated by reference herein for all purposes.

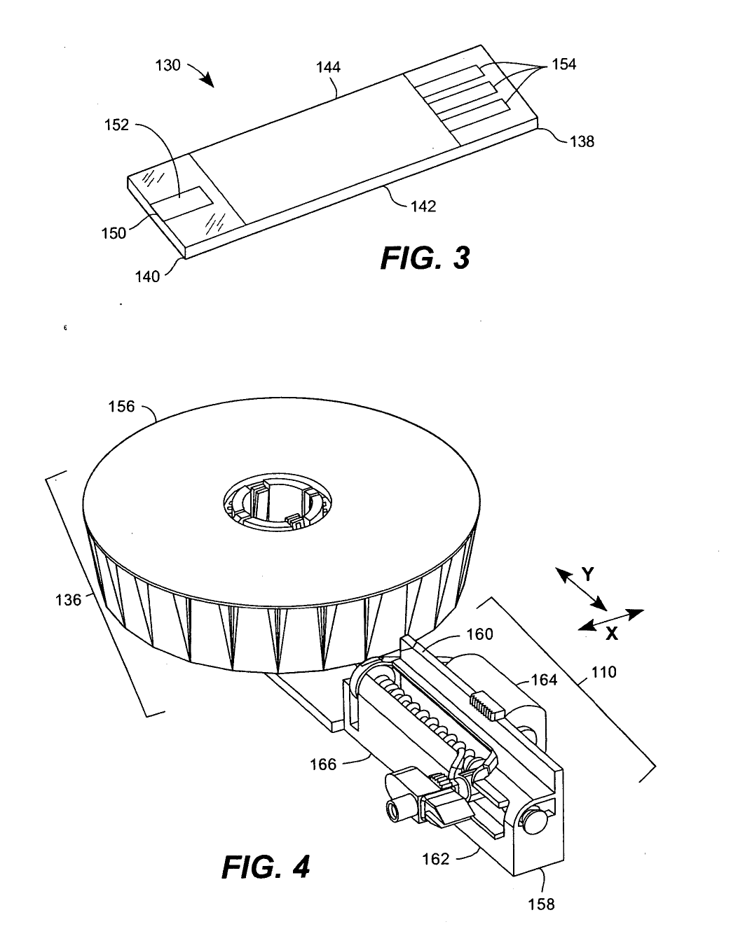

Referring to FIG. 3, an exemplary test sensor 130 that can be used in accordance with the present invention is shown. Contact electrodes 154 are located on proximal end 138 of test sensor 130 and can form an electrical connection between test sensor 130 and the measuring device or circuit of metering system 100 during a desired test procedure. Sample application area 150 and sample fill indictor window 152 are located on distal end 140 of test sensor 130, as shown. Test sensor 130 may be electrochemical or photometric, examples of which are disclosed in U.S. patent application Ser. No. 10/860,180 (LifeScan Attorney docket number DDI 5009 USNP, filed on Jun. 2, 2004) and U.S. Provisional Patent Application No. 60/516,252 (LifeScan Attorney docket number DDI 5015, filed on Oct. 31, 2003), the entire disclosures of which are fully incorporated herein by reference for all purposes. Test sensor 130 may also be an integrated test sensor, which comprises a test sensor and a dermal tissue penetration member, examples of which are disclosed in International Application No. PCT/GB01/05634 (published as WO 02/49507 on Jun. 27, 2002) and U.S. patent application Ser. No. 10/143,399, the entire disclosures of which are incorporated herein by reference for all purposes.

As shown in FIG. 2, metering system 100 includes outer housing 124, upper housing portion 112, first longitudinal side 116, second longitudinal side 118, distal end 120, proximal end 122, sensor delivery port 126, and user interface 128. Sensor delivery port 126 is preferably located on proximal end 122 of metering system 100 and is adjacent to, or located closest to, second longitudinal side 118 in the illustrated embodiment. User interface 128 is located on upper housing portion 112 of outer housing 124 of metering system 100, and includes, for example, a plurality of buttons 131, 132, 133, and a visual display 134 of liquid crystal or other display type to assist a user in the operation of metering system 100. With a cartridge assembly 136 loaded in transport mechanism 110 of metering system 100, depressing, for example, button 132 can cause transport mechanism 110 to load a test sensor 130 into sensor delivery port 126 where it is accessible by a user for performing a test, as will be described in more detail below.

Referring to FIG. 2, outer housing 124 of metering system 100 defines an internal cavity 146 of sufficient size to wholly contain and to support transport mechanism 110 and cartridge assembly 136. Transport mechanism 110 resides within the internal cavity 146 of metering system 100 such that distal end 156, proximal end 158, first longitudinal side 164, and second longitudinal side 166 of transport mechanism 110 correspond to distal end 120, proximal end 122, first longitudinal side 116, and second longitudinal side 118 of metering system 100, respectively. Transport mechanism 110 can remove test sensor 130 from storage position 129 of cartridge assembly 136 and subsequently reorient and reposition test sensor 130 to test position 135 thus advantageously enabling the user to simultaneously view both fill indicator window 152 of test sensor 130 and user interface 128 of metering system 100. In this way, the user can advantageously use metering system 100 on a horizontal surface.

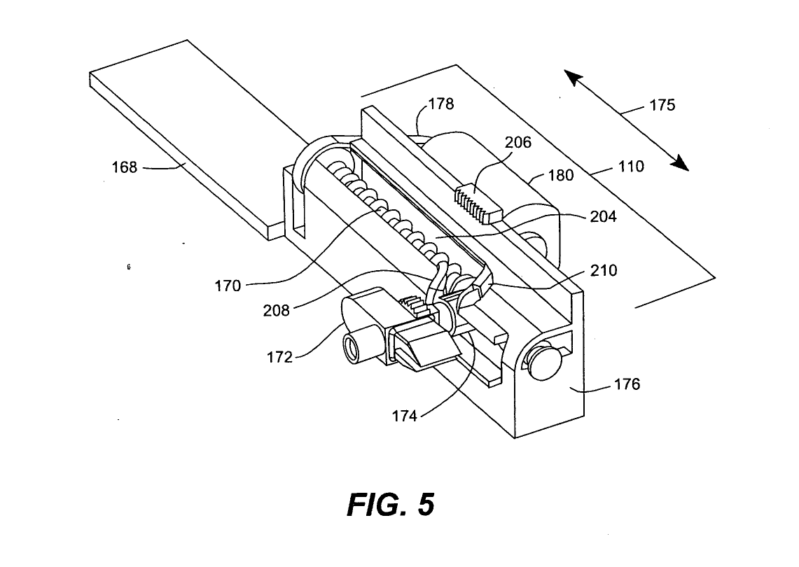

Referring to FIGS. 4 and 5, transport mechanism 110 includes distal end 156, proximal end 158, upper surface 160, lower surface 162, first longitudinal side 164, and second longitudinal side 166. As shown, transport mechanism 148 also includes cartridge stabilizer 168, lead screw 170, connector 172, carriage 174, frame 176, belt 178, and motor 180.

Cartridge stabilizer 168 preferably provides a platform for operatively positioning cartridge assembly 136 relative to transport mechanism 110 when cartridge assembly 136 is positioned in metering system 100. As shown, cartridge stabilizer 168 is planar and rectangular in shape and is designed to provide a desired positional relationship between cartridge assembly 136 and transport mechanism 110. In this regard, cartridge assembly may include a receiver, hub, engaging mechanism, or the like for cooperatively positioning a particular source of test sensors relative to transport mechanism 110 such as cartridge assembly 136. In addition, cartridge stabilizer 168 may be designed to provide electrical connections (not shown) in the form of leads or the like between cartridge assembly 136 and metering system 100 that can be used to provide communication between cartridge assembly 136 and metering system 100. In any event, any desired mounting platform, frame, structure, device, mechanism, or the like can be used to position any desired source of test sensors relative to transport mechanism 110 so that a desired test sensor can be moved between a storage position or the like of the cartridge assembly and a test position of the metering system in accordance with the present invention.

Generally, lead screw 170 is operatively rotatably supported by frame 176 so that lead screw 170 can rotate relative to frame 176. Carriage 174 is drivingly engaged with lead screw 170 and carries connector 172 with respect to transport mechanism 110. Connector 172 functions to carry a test sensor. In operation, rotation of lead screw 170, as driven by motor 180 and belt 178 drives carriage 174, and thus connector 172, along conveying direction 175. In this regard, any known or future developed drive technique can be used to rotationally drive lead screw 170.

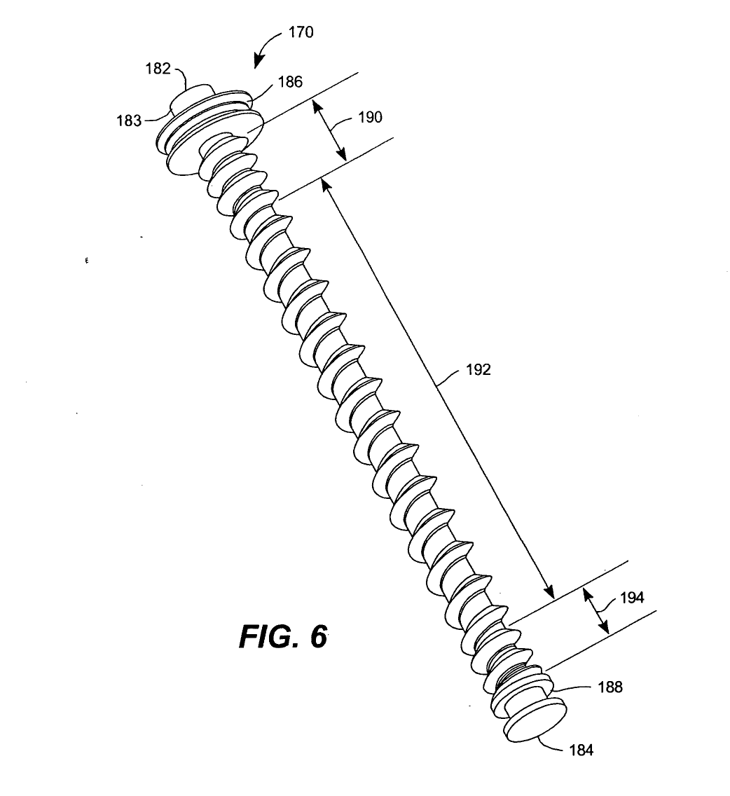

Lead screw 170 is illustrated separately from frame 176 in FIG. 6 and includes bearing 183 for rotatably supporting lead screw 170 in frame 176, and groove 186 for providing clearance for drive belt 178 at distal end 182. Another bearing 188 is provided at proximal end 184 for rotatably supporting lead screw 170 in frame 176.

Lead screw 170 preferably comprises collection pitch 190, transfer pitch 192, and presentation pitch 194. Collection pitch 190 is located toward distal end 182 of lead screw 170 and is used to control the movement of connector 172 as connector 172 extracts test sensor 130 from cartridge assembly 136. Transfer pitch 192 is located centrally within lead screw 170 and is used to provide control of connector 172 as it is rotated, as described in more detail below. Presentation pitch 194 is located toward the proximal end 184 of lead screw 170 and is used to provide smooth directed control over connector 172 as connector 172 extends test sensor 130 out of sample delivery port 126 of metering system 100. Transfer pitch 192 is typically larger (i.e., the turns in the screw are more widely spaced) than collection pitch 190 and presentation pitch 194. Collection pitch 190 and presentation pitch 194 are preferably different from transfer pitch 192. In this way, collection pitch 190 can provide greater control and power transfer when collecting a test sensor 130 from cartridge assembly 136, such as when breaching a foil barrier or the like. Collection pitch 190 and presentation pitch 194 can be similar or different.

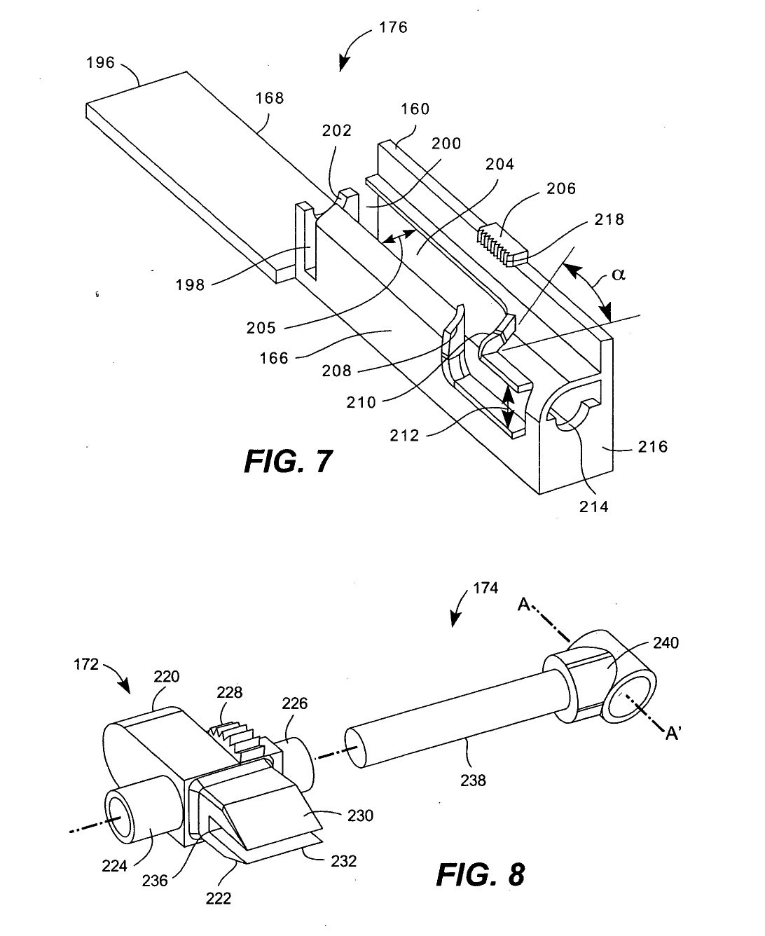

In FIG. 7, a perspective view of frame 176 of transport mechanism 110 is shown. As illustrated, frame 176 includes bearing surface 202 at distal end 196 for receiving bearing 183 of lead screw 170 and bearing surface 214 at proximal end 216 for receiving bearing 188 of lead screw 170. Frame 176, as shown, includes slot 204 for containing lead screw 170. Guide opening 205 on upper surface 160 of transport mechanism 110 extends from bearing surface 202 to first and second cam surfaces 208 and 210. Guide opening 205 is of sufficient width to allow movement of carriage 174 within slot 204 while driving connector 172 as carried by carriage 174. Frame 176 also includes a rack gear 206 positioned adjacent guide slot 204. Rack gear 206 cooperatively functions together with pinion gear 228 of connector 172 to rotate connector as carriage 174 is driven along conveying direction 175 by lead screw 170. As shown, lead screw 170, pinion gear 228, and rack gear 206 are designed to cause a 180 degree rotation of connector 172. This motion essentially causes the orientation of a test sensor removed from (or being returned to) cartridge assembly 136 to be reversed with respect to conveying direction 175 as driven by lead screw 170.

As illustrated, first and second cam surfaces 208 and 210 are curvilinear and form an angle α preferably ranging from about 30 to 45 degrees. As shown, guide slot opening 205 changes direction to open on second longitudinal side 166 of transport mechanism 110. As illustrated, this change of direction of guide slot opening 205 from upper surface 160 to second longitudinal side 166 allows carriage 174 and connector 172 to rotate test sensor 130 from a first position (such as in a position that is normal to the test position, for example) to a second position (in a position that is parallel to the test position). Frame 176 also includes opening 198 that functions to provide clearance for belt 175 in connecting belt 175 between lead screw 170 and motor 180.

Referring to FIG. 8 an exploded perspective view of connector 172 and carriage 174 of transport mechanism 110 is shown separate from frame 176 and lead screw 170. Connector 172 includes distal end 220, proximal end 222, sleeve 224 and 226, pinion gear 228, upper sensor engaging arm 230, lower sensor engaging arm 232 and strip engaging elements (not visible). Connector 172 also preferably includes electrical leads (not shown) for providing an electrical connection(s) between strip engaging elements and a measuring device or circuit metering system 100. The electrical leads can be conductive tracks between the strip engaging elements and a measuring device or circuit metering system 100, for example. Upper sensor engaging arm 230 and lower sensor engaging arm 232 are separated by a space 236 that contacts proximal end 138 of test sensor 130 when a test sensor 130 is engaged by connector 172.

As shown, carriage 174 includes rod 238 and connector 240. Connector 240 connects to rod 238 so that rod 238 is substantially normal to a longitudinal axis A-A′ of connector 240. Preferably this connection is fixed so that no rotation can occur between rod 238 and connector 240. Rod 238 also engages with sleeves 224 and 226 so that connector 172 can rotate with respect to connector 240 as driven by engagement of pinion 228 with rack gear 206. It is contemplated that the connection between rod 238 and sleeves 224 and 226 may be fixed while rotation between rod 238 and connector 240 is permitted. Connector 240 also includes an internal thread that engages with lead screw 170 such that when motor 180 is activated and lead screw 170 rotates, carriage 174 maintains a linear movement in both directions of lead screw 170, depending on the direction of movement of lead screw 170.

While the exemplary embodiment of a transport mechanism in accordance with the present invention described above comprises a carriage driven by a lead screw, other driving mechanisms or devices are contemplated. Any known or future developed mechanism, device, or system capable of moving a carriage along a linear path may be used. For example, instead of a lead screw, a carriage can be carried by a belt driven by gears or pulleys or the like. Also, a rack gear linearly extendable by a drive gear can be used to drive a carriage in accordance with the present invention. Generally, any mechanism or device that can drive a carriage and/or connector in accordance with the present invention can be used.

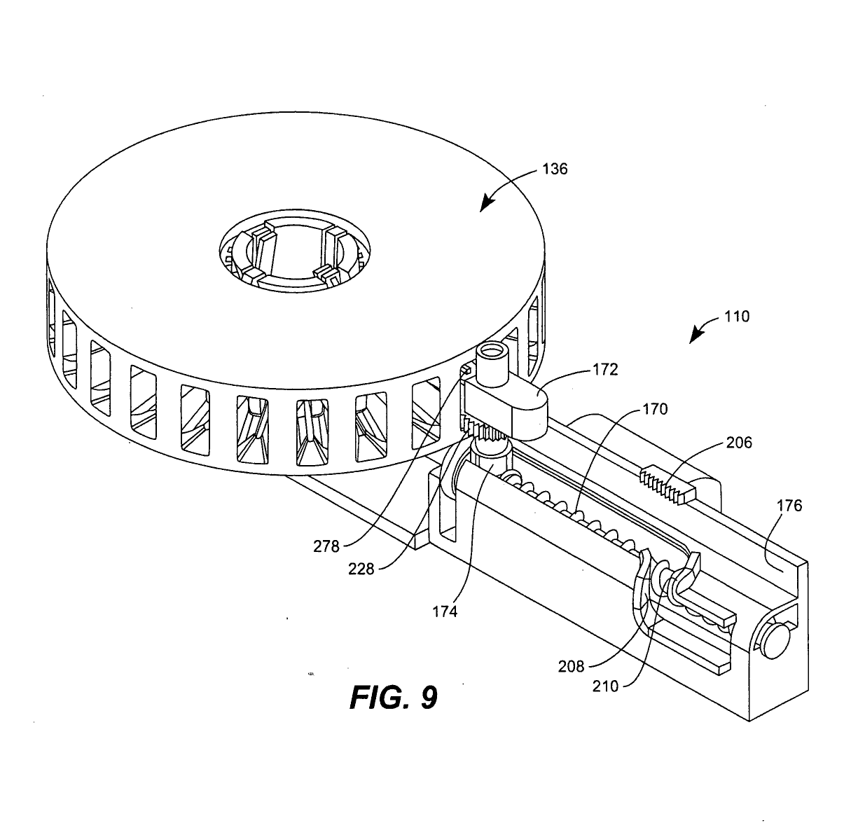

In use, transport mechanism 110 can transport test sensor 130 between storage position 129 of cartridge assembly 136 and test position 135. An exemplary series of positions for a single test sensor is illustrated in FIGS. 9-13 and described in detail below. These methods describe various positions for dispensing a test sensor 130 that may be done in reverse to return a test sensor 130 to cartridge assembly 136 after a test for storage and future disposal. In the exemplary illustrated embodiment, this is done by rotating the test sensor about 180 degrees on a first axis and rotating the test sensor by about 90 degrees on a second axis that is preferably normal to the first rotation axis. In this way, the rotation of test sensor 130 from its position within the cartridge assembly to its test position within sample delivery port 126 orients the sample application area 150 of the test sensor 130 relative to the visual display 134 of the metering system 100 such that the user can read the instructions on the visual display 134 without moving or rotating the metering system 100.

Referring to FIG. 9 in particular, connector 172 of transport mechanism 110 is shown engaging with test sensor 130 at storage position 129 within test sensor chamber 278. Connector 172 may comprise engaging elements (not visible) that grasp or engage with test sensor 130 with enough force to remove test sensor 130 from sensor chamber 278. That is, the engaging elements grab or grasp the test sensor with a stronger grip than that which is holding the test sensor in the cartridge. Exemplary engaging elements that can be used are described in U.S. patent application Ser. No. 10/666,154 filed on Sep. 19, 2003, the entire disclosure of which is incorporated by reference herein for all purposes. Connector 172, as carried by carriage 174, has been driven by lead screw 170 to this position. Collection pitch 190 of lead screw 170 preferably allows controlled motion for engaging with test sensor 130. Depending on the particular type of cartridge assembly used, connector 172 may need to rupture or breach a foil seal or the like on the outside of the cartridge that protects the test sensor. In this regard, connector 172 is preferably designed for breaching such a seal and may include cutting or piercing elements or blades or the like. In one exemplary application, the force required for connector 172 to engage with test sensor 130 is approximately 2 Newtons.

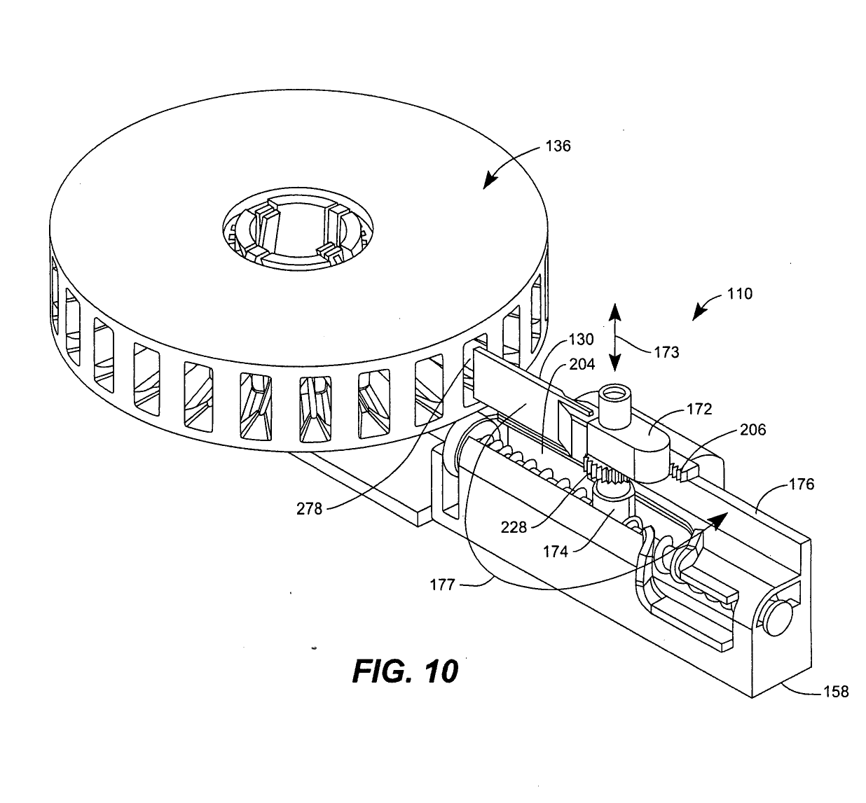

Connector 172 and engaged test sensor 130 are then extracted from chamber 278, as shown in FIG. 10. To extract test sensor 130 from chamber 278, lead screw 170 linearly drives carriage 174 along conveying direction 175 toward proximal end 158 of transport mechanism 110. As shown, test sensor 130 is thus oriented “on-edge” or in a position that is normal to test position 135.

With reference to FIG. 10, as carriage 174 is driven along conveying direction 175 toward proximal end 158 of transport mechanism 110, pinion gear 228 engages with rack gear 206. Engagement of pinion gear 228 and rack gear 206 cooperatively rotates connector 172 and test sensor 130 about 180 degrees on rotation axis 173 in a rotational direction indicated arrow 177. This causes sample application area 150 on distal end 140 of test sensor 130 to be directed towards proximal end 158 of transport mechanism 110 as shown. Along this path, guide slot 204 preferably functions to at least partially guide carriage 174.

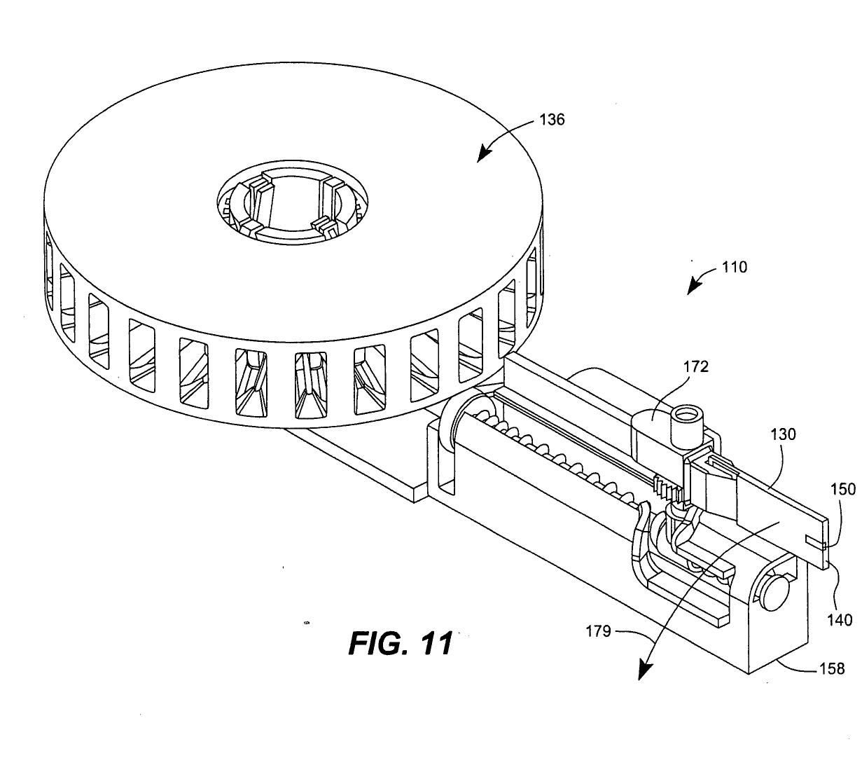

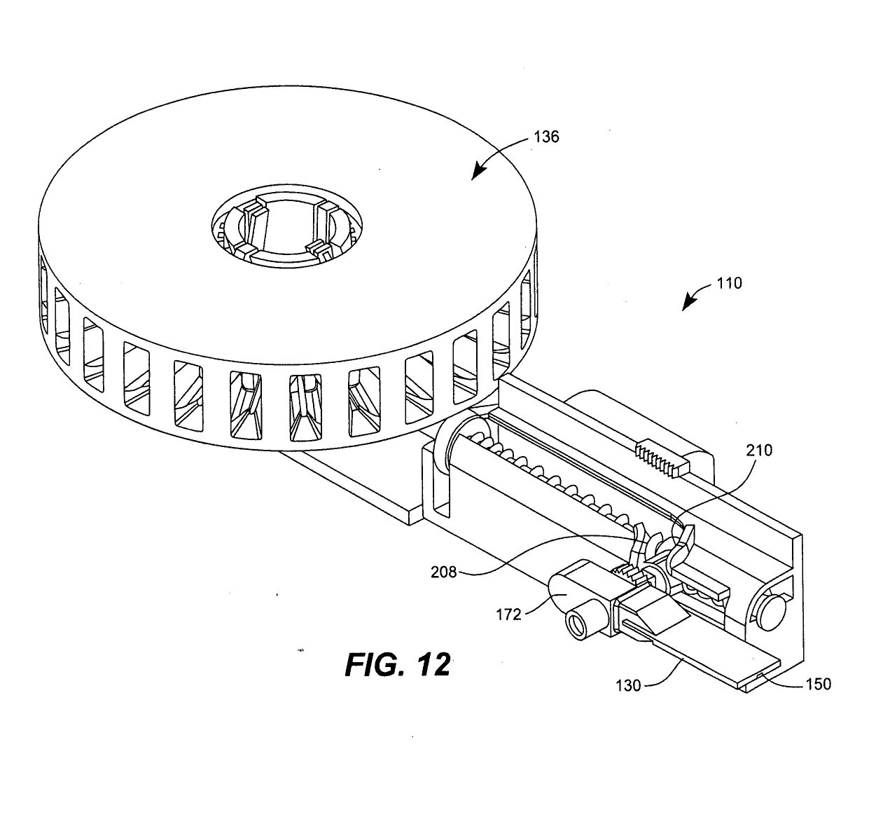

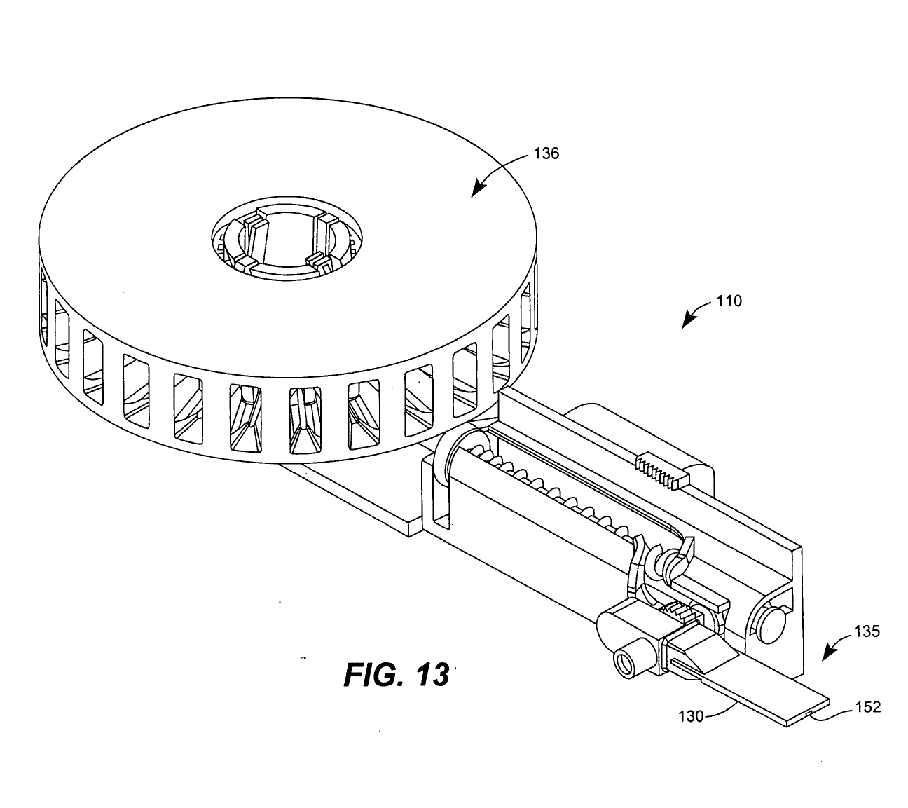

As carriage 174 is driven along conveying direction 175, carriage 174 contacts and is directionally guided by cam surfaces 208 and 210, as can be seen in FIG. 11. This guiding action causes carriage 174 to rotate on lead screw 170 in a rotational direction indicated by arrow 179, which causes test sensor 130 to rotate about 90 degrees relative to the position shown in FIG. 12. Continued driving by lead screw 170 moves test sensor 130 into test position 135 as shown in FIG. 13. After a test is completed, test sensor 130 can be returned to storage position 129 of cartridge assembly 136. This can be done by reversing the direction of lead screw 170 to drive carriage 174 and connector 172 along a path generally opposite of that described above. Connector 172 pushes the test sensor 130 back into the cartridge assembly 136 in a way that the grip on the test sensor 130 by the cartridge assembly 136 is greater that the grip on the test sensor by connector 172. This can be done by having a return position in the cartridge assembly 136 that is different from the original position of the test sensor 130 in the cartridge assembly 136. For example, connector 172 can push the test sensor 130 further into the cartridge assembly 136 than it was when it was first removed from the cartridge assembly 136.

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

What is claimed is:

1. A transport apparatus for moving a test sensor between a first location in an analyte measurement system where the test sensor has a first planar orientation to a second location in the analyte measurement system where the test sensor has a second planar orientation that is different from the first planar orientation, the transport apparatus comprising:
a frame;
a driving device operatively integrated with the frame;
an connector for carrying a test sensor, the connector driveable along a conveying direction by the driving device and positionable at a first location where a test sensor engaging surface of the connector has a first planar orientation;
a first reorientation system that cooperates with the driving device to rotate the connector in a first rotational direction having an axis of rotation normal to the conveying direction; and
a second reorientation system that cooperates with the driving device to rotate the connector in a second rotational direction having an axis of rotation extending along the conveying direction so that the connector is positionable at a second location where the test sensor engaging surface of the connector has a second planar orientation different from the first planar orientation.

2. The apparatus of claim 1, wherein the connector is rotatably mounted on a carriage operatively engaged with the driving device.

3. The apparatus of claim 2, wherein the driving device comprises a lead screw having a drive axis extending along the conveying direction.

4. The apparatus of claim 2, wherein the first reorientation system comprises a pinion integrated with the carriage and engageable with a rack gear integrated with the frame to rotate the connector in the first rotational direction as the connector is driven along the conveying direction by the driving device.

5. The apparatus of claim 4, wherein the rack and pinion can rotate the connector by about one hundred and eighty degrees in the first rotational direction.

6. The apparatus of claim 2, wherein the second reorientation system comprises a guide surface of the carriage that can slidingly contact a guide surface provided integrated with the frame to rotate the connector in the second rotational direction as the connector is driven along the conveying direction by the driving device.

7. The apparatus of claim 6, wherein the guide surface of the carriage and the guide surface integrated with the frame can rotate the connector by about ninety degrees in the second rotational direction.

8. The apparatus of claim 1, wherein the connector comprises one more engaging element for holding a test sensor carried by the connector.

9. The apparatus of claim 8, wherein the one or more engaging element can provide an electrical connection between a test sensor held by the connector and an analyte measurement system.

10. An analyte measurement system comprising:
a housing;
an indexing device provided within at least a portion of the housing and that can receive a cassette having a plurality of test sensors and position a test sensor of the plurality of test sensors at a storage location where the test sensor has a first planar orientation; and
a transport device provided within at least a portion of the housing that can move a test sensor between the storage location and a test location where the test sensor has a second planar orientation different from the first planar orientation.

11. The system of claim 10, wherein the transport device can rotate a test sensor on a first rotational axis about one hundred and eighty degrees relative to the position of the test sensor in the storage location.

12. The system of claim 11, wherein the transport device can rotate the test sensor on a second rotational axis normal to the first rotational axis about ninety degrees relative to the position of the test sensor in the storage location.

13. The system of claim 10, wherein the second planar orientation is similar to the planar orientation of a display screen of the system.

14. The system of claim 10, wherein the transport device comprises:
a frame;
a driving device operatively integrated with the frame;
a connector for carrying a test sensor, the connector driveable along a conveying direction by the driving device and positionable at a first location where a test sensor engaging surface of the connector has a first planar orientation;
a first rotating device that cooperatively operates with the driving device to rotate the connector in a first rotational direction having an axis of rotation normal to the conveying direction; and
a second rotating device that cooperatively operates with the driving device to rotate the connector in a second rotational direction having an axis of rotation extending along the conveying direction so that the connector is positionable at test location where the test sensor engaging surface of the connector has a second planar orientation different from the first planar orientation.

15. The system of claim 10 in combination with a cassette having at least one test sensor provided therein.

16. A method of providing a test sensor in a test position relative to an analyte measurement system, the method comprising the steps of:
providing an analyte measurement system with a cassette having one or more test sensors;
positioning a test sensor of the one or more test sensors of the cassette in a storage location where the test sensor has a first planar orientation;
removing the test sensor from the cassette with a transport device of the analyte measurement system;
rotating the test sensor with the transport device on a first rotational axis by a first angular rotation relative to the position of the test sensor in the storage location;
rotating the test sensor with the transport device on a second rotational axis normal to the first rotational axis by a second angular rotation relative to the position of the test sensor in the storage location; and
positioning the test sensor at a test position where the test sensor has a second planar orientation different from the first planar orientation.

17. The method of claim 16, comprising linearly conveying the test sensor along a conveying direction while rotating the test sensor with the transport device on the first rotational axis.

18. The method of claim 17, comprising linearly conveying the test sensor along the conveying direction while rotating the test sensor with the transport device on the second rotational axis.

19. The method of claim 16, comprising rotating the test sensor on the first rotational axis before rotating the test sensor with the transport device on the second rotational axis.

20. The method of claim 16, comprising returning the test sensor to the staging location.

21. The method of claim 16, wherein the first angular rotation comprises about one hundred and eighty degrees.

22. The method of claim 16, wherein the second angular rotation comprises about ninety degrees.
